(19) United States
(12) Patent Application Publication
(10) Pub. No.: US 2015/0331856 A1
(43) Pub. Date: Nov. 19, 2015

(54) TIME-BASED CONTENT AGGREGATOR

(71) Applicant: Cie Digital Labs, LLC, Long Beach, CA (US)

(72) Inventors: Justin Yoo Choi, Newport Coast, CA (US); Tyler Tanaka, Costa Mesa, CA (US)

(21) Appl. No.: 14/700,383

(22) Filed: Apr. 30, 2015

Related U.S. Application Data
(60) Provisional application No. 61/986,599, filed on Apr. 30, 2014.

(51) Int. Cl. G06F 17/30

(52) U.S. Cl. CPC G06F 17/3002; G06F 17/30312

(57) ABSTRACT

Techniques to aggregate and provide a time-based feed of content from a plurality of sources are disclosed. In various embodiments, a time-stamped index of content items from a plurality of content sources is obtained, wherein the time-stamped index associates at least a subset of content items with an event. The time-stamped index and said at least a subset of the content items are used to provide a content feed associated with the event, wherein the content feed includes content from at least two or more of said plurality of sources arranged at least in part by time through a duration of occurrence of the event.

### CROSS REFERENCE TO OTHER APPLICATIONS

This application claims priority to U.S. Provisional Patent Application No. 61/986,599 entitled CONTENT PLAYER filed Apr. 30, 2014 which is incorporated herein by reference for all purposes.

### BACKGROUND OF THE INVENTION

Active and passive participants in real world events, such as conferences, sporting events, music concerts, political rallies, often generate large quantities of related content in various forms and distributed at least initially through a variety of channels. Participants, observers, commentaries, and their various communities of friends, followers, readers, viewers, etc. often will continue to generate content for a time after the real world event has been concluded.

Examples of such content include, without limitation, photos, videos, comments, and other posts via social media services (e.g., Facebook®, Twitter®, Instagram®, etc.); blog posts, articles, reviews, reader comments, etc. posted online; news reports, articles, opinion pieces, commentary, and other content generated by formal and informal news sources; live or record video, audio, or other broadcast content of the event itself, such as a live and/or recorded broadcast of an event, e.g., a sporting event.

Consumers of such participant and/or observer generated content may miss content that would have been of interest to them and/or may be inundated with secondary content that is of no interest to them since content is distributed across various channels, feeds, and sites and that the content is usually organized by the content creator and not by subject matter

Some such content may not be created and/or become available until after an event. In some cases, the social or other significance of an event is not appreciated fully until sometime after the event, which may result in relevant content being created after the event and/or content created during the event coming to be recognized as being of greater value or interest than previously thought.

### BRIEF DESCRIPTION OF THE DRAWINGS

Various embodiments of the invention are disclosed in the following detailed description and the accompanying drawings.

FIG. 1 is a block diagram illustrating an embodiment of a system to create a replayable content stream.

FIG. 2 is a block diagram illustrating an embodiment of a system to provide a replayable content stream.

FIG. 3 is a flow chart illustrating an embodiment of a process to create a replayable content stream.

FIG. 4 is a block diagram illustrating an embodiment of a mobile device user interface to discover content streams.

FIG. 5 is a block diagram illustrating an embodiment of a mobile device user interface to explore content streams.

FIG. 6A is a block diagram illustrating an embodiment of a content player user interface.

FIG. 6B is a block diagram illustrating an embodiment of a content stream playback speed control interface.

FIG. 7 is a flow chart illustrating an embodiment of a process to replay a content stream.

FIG. 8A is a block diagram illustrating an embodiment of a content index data structure to provide a replayable content feed.

FIG. 8B is a block diagram illustrating an example of a portion of a taxonomy to classify content in an embodiment of a content stream generation and/or playback system.

FIG. 9 is a flow chart illustrating an embodiment of a process to update index metadata.

FIG. 10 is a flow chart illustrating an embodiment of a process to learn user preferences.

FIG. 11 is a block diagram illustrating an example of a social graph such as may be used in an embodiment of a content stream creation and/or playback system.

FIG. 12 is a flow chart illustrating an embodiment of a process to provide synchronized playback of a content stream.

FIG. 13 is a flow chart illustrating an embodiment of a process to manage content storage.

FIG. 14 is a diagram illustrating an example of a location-based content stream discovery interface in an embodiment of a content player system.

FIG. 15 is a flow chart illustrating an embodiment of a process to prompt users to provide content.

FIG. 16 is a flow chart illustrating an embodiment of a process to create a custom content feed.

FIG. 17 is a flow chart illustrating an embodiment of a process to promote user engagement with content.

FIG. 18 is a diagram illustrating an example of a virtual “sticker” palette user interface in an embodiment of a content player system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques to capture, index, and correlate content from multiple sources and to use the resulting meta-information to provide replayable content streams are disclosed.

In various embodiments, content streams may be generated and provided in real time to provide a “live” stream of correlated content from multiple disparate sources. For example, a live media broadcast (stream) of an event, e.g., a sporting event, may be included in a live content stream that also includes user images, video, and text content generated while viewing the live event and/or broadcast, such as social media posts, online live updates, etc.

In various embodiments, the techniques disclosed herein are directed to indexing content streams from, for example, social channels (such as Twitter, Facebook, Vine, and Instagram) and/or any other content sources (such as periodicals, blogs, publications, television broadcasts, video feeds, YouTube, and/or any other content sources). The indexed content from various sources may be organized by time, sorted by popularity, and also organized into sub-contexts and may be viewed live or stored (e.g., recorded). The live content can be viewed in a continuous feed. The stored content may be viewed (e.g., in a context of a map, feed, etc.), played back, and/or replayed (e.g., on demand, at a later time). In various embodiments, the techniques disclosed herein provide a recorder for social and/or other content. Disclosed herein in various embodiments is a social content digital video recorder (DVR).

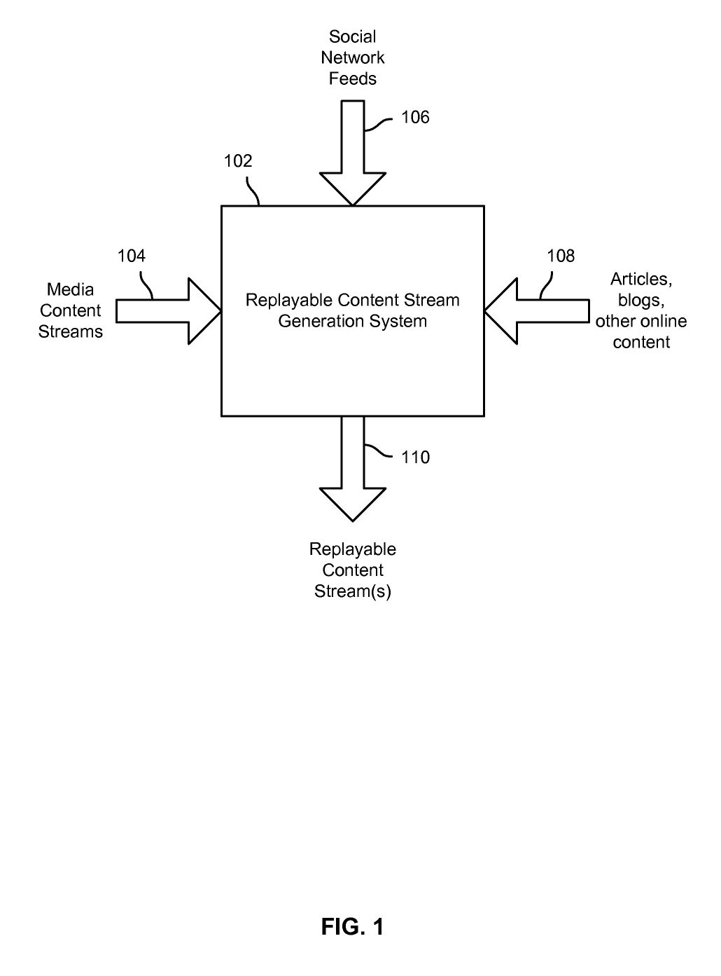

FIG. 1 is a block diagram illustrating an embodiment of a system to create a replayable content stream. In the example shown, a replayable content stream generation system 102 receives, e.g., via a network or other communication interface (not shown) media content streams 104; social network feeds 106; articles, blogs, and other online content 108; and/or other content. In various embodiments, the replayable content stream generation system indexes, timestamps (if not already present), and correlates content from multiple disparate sources, such as those shown in FIG. 1, and generates a multi-modal content stream that provides an ability to view related content from multiple disparate sources concurrently in a time-synchronized manner.

For example, in some embodiments, content associated with a significant event, such as the Winter Olympics, may be gathered from a variety of sources (network TV video stream of events; social media, online, or other commentary on same; images and/or video posted on social media or elsewhere by event attendees; etc.). In various embodiments, live or recorded video or audio of the event itself; commentary, user images/video, etc. created as events unfolded; articles, analysis, or commentary provided after the event in response to content posted or otherwise published by others; etc. may be included. A timeline-based display may be provided, enabling users to browse or view content associated with events that occurred through a relevant period. For example, in the case of the Winter Olympics, content relating to competition events that occurred through the course of a day by using a timeline or other user interface to navigate and/or browse through a content feed that includes content from a variety of sources correlated based on time of day. For example, a portion of the content feed relating to a time of day within a competition day at the Winter Olympics during which a speed skating race of a certain distance was taking place in one venue at the same time a significant hockey game was being played in another venue might include images, video clips, social media comments or other text-based content, etc. associated with both events.

In various embodiments, content feeds generated as shown in FIG. 1 may be streamed live, as an event occurs, and/or may be stored for later playback.

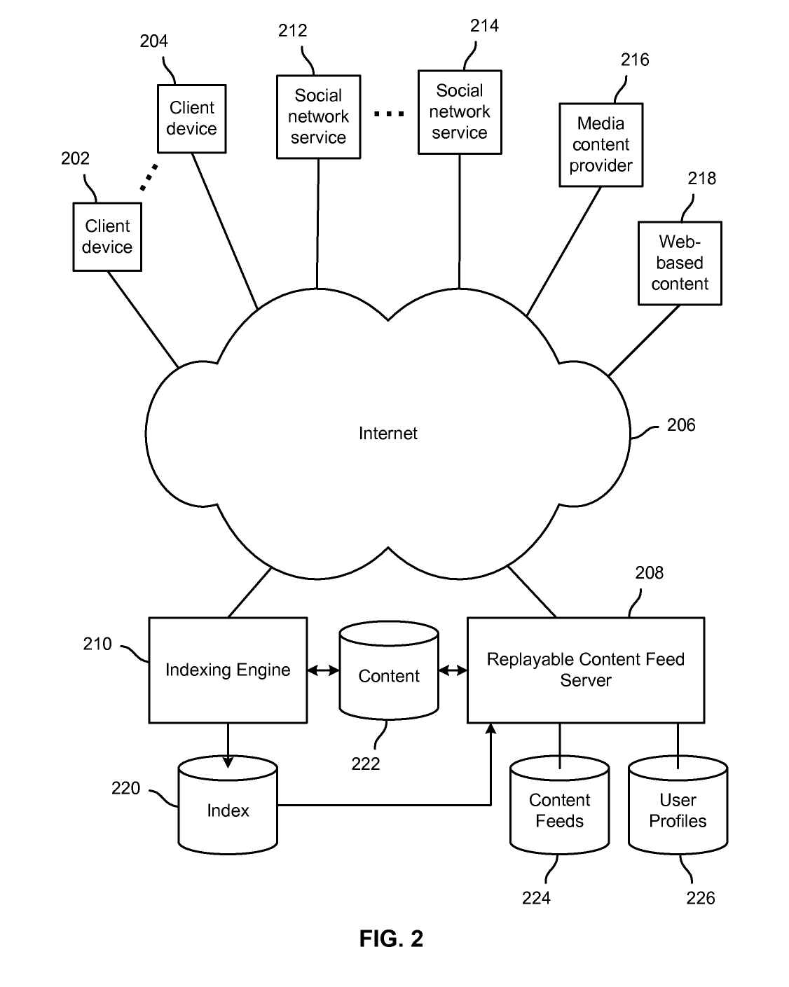

FIG. 2 is a block diagram illustrating an embodiment of a system to provide a replayable content stream. In the example shown, client devices, represented in FIG. 2 by devices 202 and 204, have access via the Internet 206 to a replayable content feed server 208 configured to provide content feeds, e.g., feeds generated as shown in FIG. 1.

In the example shown in FIG. 2, an indexing engine 210 receives and indexes content from a variety of sources, such as social network services (represented by services 212, 214); media content providers, such as broadcast or other TV networks (represented by media content provider 216); and other web-based content, such as articles, blogs, reviews, comments, etc. (represented by web-based content source 218). In various embodiments, social network feeds may be obtained via an API of each respective social media service. Media content may be obtained by contracting and/or subscribing to receive an associated media stream, which may be parsed, time stamped, and otherwise indexed, as described herein. Content from web-based sources may be obtained by subscribing to RSS or other feeds and/or by crawling web pages.

In the example shown, index data is stored in an index 220, e.g., a database table or other data structure. Indexed content and/or pointers thereto may be stored in a content store 222. In some embodiments, only a subset of received content may be stored, as discussed more fully below.

In some embodiments, content may be indexed using a variety of approaches. For example, content may be indexed by one or more keywords, hash tags, subject matter, topics, locations, sources (e.g., username, @ handle), periods of time, tags, metadata, image processing, such as automated detection of image content and/or subject matter, and/or other data. In one example, content indexing may be achieved by a hashtag. The hashtag “#Olympics” may, for example, be used to aggregate content around the Olympics. In another example, a user generated image (e.g., from a user's Instagram feed) may be identified through automated image subject matter determination as an image of a bobsled, in some embodiments resulting in index or other text-based metadata identifying the image as an image of a bobsled being generated and stored.

According to some embodiments, keywords in the content may be indexed, thereby allowing a greater ability to deliver relevant and interesting content back to users for events and/or places. Keywords in combination with official @ handles, user names, hashtags, and/or other identifiers will allow a more targeted feed. This data may also be used to sort the content into subcategories. For example, users may see an image of the bobsled event during the winter Olympics and will be able to dive deeper into related content specific to the bobsledding event. Additionally, image data such as colors, shapes, geolocation, and other image information may be used to improve this subcategorization. The subcategorization allows users to dive deeper into a specific subset of the event and enables them to see more content around a specific aspect of the event.

In various embodiments, content may be analyzed to determine topic(s) associated with a content stream, and content related to the determined topic may be indexed, e.g., by indexing engine 210. For example, topics may be determined based on combinations and/or groups of keywords, hashtags, and/or other data.

In some embodiments, the techniques disclosed herein may provide an easy way to review historical content on content streams. This may be achieved by adding time stamp data and/or other metadata and archiving the content, e.g., in a content store such as content store 222.

In various embodiments, intelligent algorithms may be used to weight the contextual relevance and importance of the content that is shown live and/or recorded. This may be based on social sharing, Likes, Favorites, Hearts, Shares and/or other factors used to measure popularity of content on various social platforms. Indexing engine 210 may be configured to obtain social sharing information from social media services, such as services 212, 214, e.g., by invoking application programming interfaces (API) of such services.

Referring further to FIG. 2, replayable content feed server 208 is configured in various embodiments to use index data 220 generated by indexing engine 210 and content data stored in content store 222 to determine and provide access to content feeds comprising content data from a variety of sources (e.g., 202, 204, 212, 214, 216, 218).

In the example shown, content feeds may be determined and/or filtered based at least in part on user profile data stored in a user profile database 226. Content feeds viewed by a user may be reflected in the user's profile, and in some embodiments, user engagement data, e.g. reflecting how long the user interacted with which parts of the content feed, may be stored. In some embodiments, a user's content feed related preferences may be stored in the user's profile, e.g., preferences expressed by the user explicitly, via a user interface, and/or preferences learned by observing the user's behavior, such as which content the user viewed for how long and/or at which playback speed, which content the user “liked” or otherwise indicated a favorable response to, etc.

Content feeds may include for different points of time in a content feed timeline content from two or more sources relating to a main topic of the content feed, e.g., an event, such as a news event (riots, war, celebration), an entertainment event (concert, awards program, TV series grand finale episode, stream movie); a sporting event (season end championship game, such as the Superbowl; the Olympics; etc.); etc. In various embodiments, the event may be a past event or a live event happening live at a time the content feed is being generated and provided in real time. The indexing engine 210 may generate and associated timestamp data with portions of content data received from sources that do not already provide timestamps. Timestamps may be used by the replayable content feed server 208 to generate content feeds 224, e.g., by enabling content to be correlated based on topic (or other relevance) and time. For example, content associated with a Superbowl game and associated activities broadcast from 3 pm to 11 pm Eastern time on a given day may be determined to be associated with the Superbowl by a variety of techniques (keywords, tags, other language based techniques) and may be ordered temporally based on the timestamp data.

The content feed server may be configured to generate a content feed at least in part by ensuring the feed includes content from a variety of sources, with content items for any given portion of the event timeline being arranged by size and location within a content feed display page/interface based at least in part on one or more of content relevance (e.g., highly relevant to topic), popularity (e.g., subscribers to media steam, “likes” on social media), user profile (e.g., type of content this user likes), location (e.g., filter by location to provide more content relevant to user's location, etc.

A content feed in various embodiments may be stored in content feed store 224 as a set of meta-information, e.g., indicating for each time window or moment along an event timeline a corresponding set of content items to be arranged and displayed in the feed when that part of the content feed is being displayed, including in various embodiments pointers to the corresponding content as stored in the content store 222 and/or at the original content source(s). For example, a thumbnail, preview image, or other representation of video may be stored and used to represent a segment of video content in the content feed, as indicated by content feed metadata stored in content feed store 224 (e.g., a databased or other structured data). User interaction with the representation may result in the associated video being obtained (e.g., from content store 222 and/or the original source) and rendered.

In some embodiments, topics, events, etc. may be defined dynamically based on content data received from one or more content sources. For example, in some embodiments, indexing engine 210 may use naturally language processing or other techniques to identify and define topics as having emerged as topics of interest. For example, content feeds from media outlets and social network feeds may begin to reflect reporting, comments, images, video, and other content related to a same topic, such as a major earthquake, a politically significant event such as an election or scandal, or any event or topic that suddenly generates a significant amount of interest as reflected across content sources and/or source types.

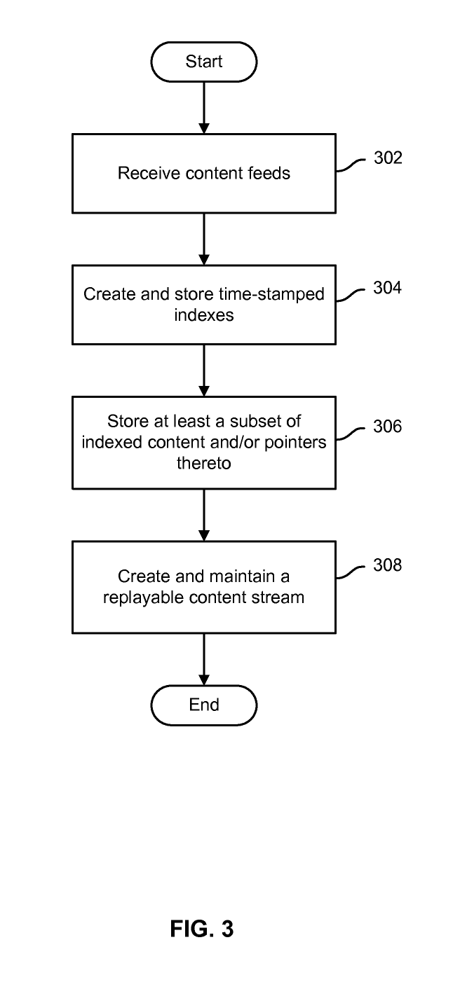

FIG. 3 is a flow chart illustrating an embodiment of a process to create a replayable content stream. In various embodiments, the process of FIG. 3 may be performed by a content stream generation system such as content stream generation system 102 of FIG. 1 and/or indexing engine 210, content feed server 208, and associated data stores (220, 222, 224, and/or 226) in the example shown in FIG. 2. Content feeds are received (302), e.g., from a variety of disparate content sources and/or source types. Time-stamped indexes of received content data are generated and stored (304). At least a subset of the indexed content and/or portions thereof may be stored (306). For example, content that is determined at the time of indexing to be primary content (e.g., video feed of an event), of high quality (e.g., by image or video processing techniques), of great interest (e.g., popularity on social media, etc.) may be cached in anticipation of later requests to play back. A replayable content stream is created and stored (308). For example, for each portion of an event timeline, content associated with the event may be identified from a plurality of sources and metadata indicating how the content should be arranged and represented within a content feed display page or other user interface may be created and stored.

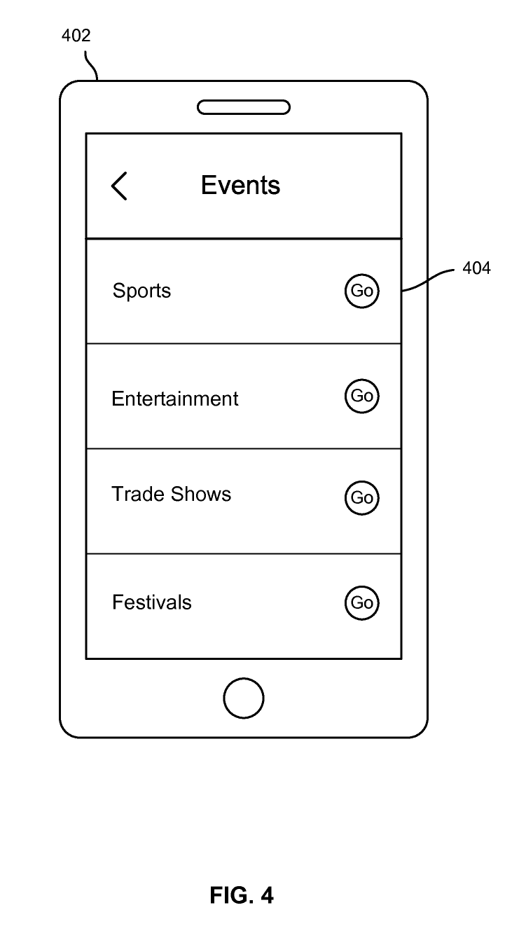

FIG. 4 is a block diagram illustrating an embodiment of a mobile device user interface to discover content streams. In various embodiments, the mobile user interface may be displayed via a client device (e.g., devices 202, 204 of FIG. 2) to provide access to content feeds. In the example shown, mobile device 402 includes a touch display device 404 configured in this example to display a mobile user interface page, e.g., via a content feed mobile app. In the example shown, the user has browsed to a page to discover content feeds associated with “events” by event type. In the example shown, event categories listed include “sports”, “entertainment”, “trade shows”, and “festivals”. In some embodiments, additional categories may be viewed by scrolling/swiping up or down, for example. Selecting the “go” control in various embodiments would result in contents feeds for events of that type being displayed in a browsable user interface. In some embodiments, which categories of events (or other subjects around which content may be aggregated and content feeds provided) are displayed and/or in which order may be determined at least in part based on a user's profile and/or preference data, e.g., as stored in a central user profile database (e.g., user profile data store 226 of FIG. 2) and/or by app preferences or settings stored on the mobile device 402.

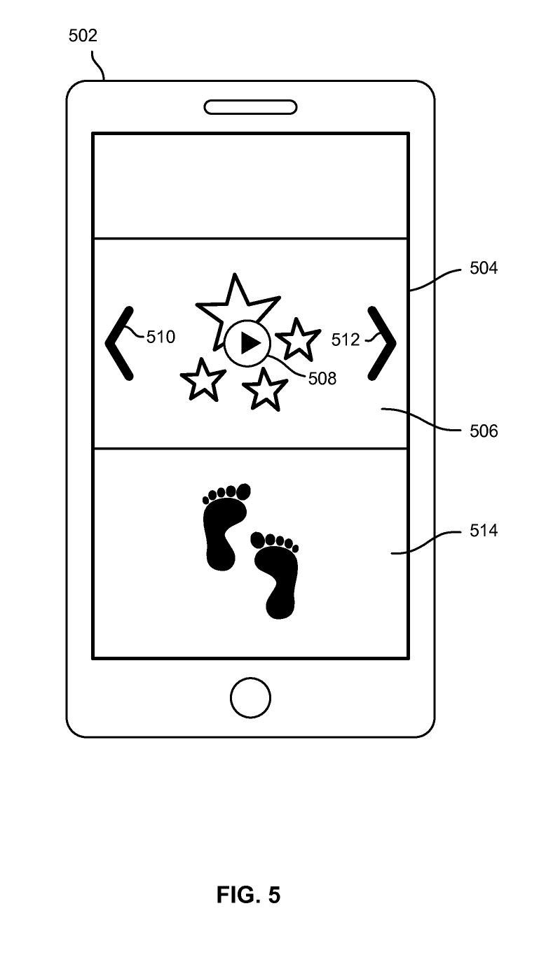

FIG. 5 is a block diagram illustrating an embodiment of a mobile device user interface to explore content streams. In some embodiments, selection of an event or other content feed category in the user interface of FIG. 4 may result in a user interface such as the one shown in FIG. 5 being displayed. In the example shown, the mobile device 502 is configured to display via display device 504 a user interface navigable in two dimensions, e.g., scrolling/swiping up/down to browse sub-topics or sub-categories of event within that event type/category, represented in some embodiments by a representation of a content feed representative of that sub-topic (e.g., a currently most popular, most timely, and/or otherwise most relevant and/or otherwise likely to be of interest content feed of that sub-type); and swiping left or right to view representations of other content feeds within that sub-category. In the example shown, a first content feed representative of a first sub-category of content feed is represented in a first frame 506, and a second content feed representative of a second sub-category of content feed is represented in a second frame 514. The first frame 506 is nearest the vertical center of the display in the example shown, and in this example that placement has resulted in a playback control 508, navigate left control 510, and navigate right control 512 being displayed. In some embodiments, selection of playback control 508 would result in the content feed currently displayed in first frame 506 being played. Selection of navigate left control 510 or navigate right control 512, and/or other inputs such as swiping left/right, in various embodiments may result in representations of other content feeds within the same sub-category being displayed in first frame 506. In some embodiments, navigating left/right may result in content associated with a different portion of a content feed currently being represented in first frame 506, e.g., earlier (left) or later (right) in time than the currently-displayed portion, being displayed in first frame 506, e.g., to enable a user to find a portion of interest more quickly.

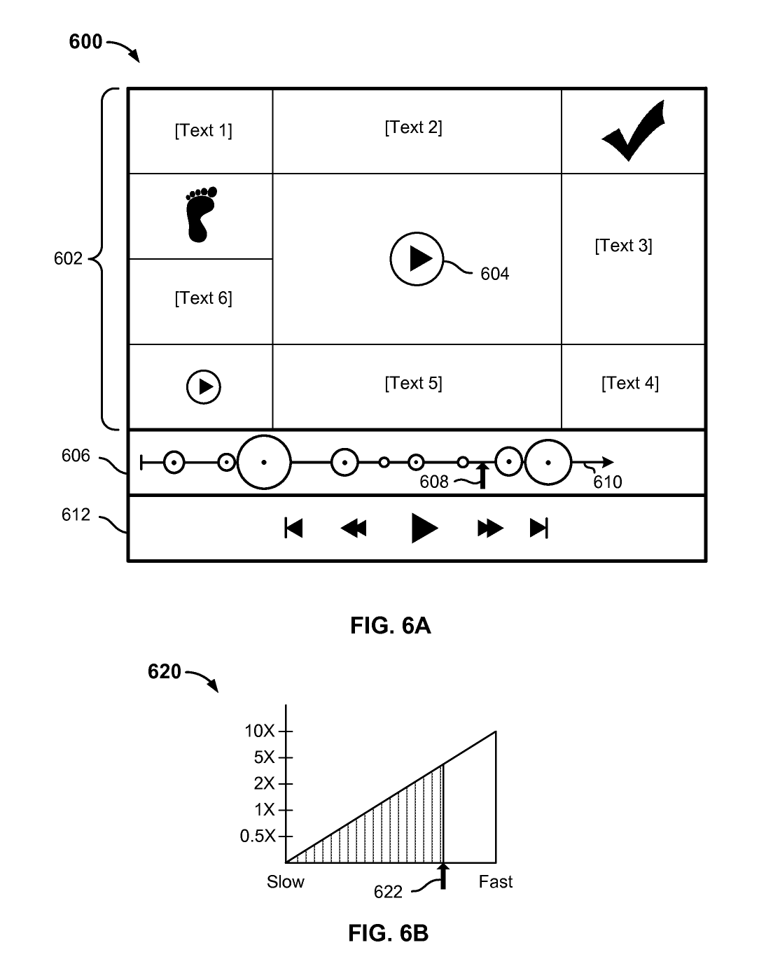

FIG. 6A is a block diagram illustrating an embodiment of a content player user interface. In various embodiments, the user interface of FIG. 6A may be displayed via a client device, such as devices 202, 204 of FIG. 2. In some embodiments, a user interface such as the one shown in FIG. 6A may be displayed on a client device that has a larger format display device, such as a desktop computer, smart television, laptop or other portable computer, tablet device, etc.

In various embodiments, content streams may be replayed. As shown in the example interface 600 of FIG. 6A, content from various sources (e.g., social media, video sites, television, etc.) may be included in an interface. Content (e.g., social media posts, videos, etc.) may be associated with a time stamp (e.g., a time of posting, broadcast, etc.), and the content may be played back based on the time-stamps. For example, content related to the Olympics on a certain day from multiple sources may be replayed. Using the content player, a user can replay the events of the Olympics as documented by multiple content sources while the events were occurring.

In the example shown in FIG. 6A, content items and/or representations thereof are arranged and displayed in a grid of differently-sized frames in a content display portion 602 of the content feed playback interface 600. According to some embodiments, a user may be able to customize a content display (e.g., arrangement, positions, time of display, etc.) according to a wide variety of parameters. In the example shown, the content display portion 602 includes images, text, and video content. For example, in the case of a content feed associated with a day of competition at the Olympics, an official video feed of a significant competition may be represented in the largest and most central frame. Selection of a playback control 604 may result in a corresponding portion of video being played. In various embodiments, as the video is played, a dynamically changing feed of corresponding content may be displayed in the other frames comprising the content display portion 602 of interface 600. For example, as the video is played, user images and/or comments posted via social media at times associated with that portion of video may be displayed. For example, in the case of a ski jump competition, a first user's image of a landing, e.g., from an angle more advantageous than in the video, and/or a second user's comment, “Nice landing!”, may be displayed. The foregoing user content may be replaced by other content as the video continues to play, and action moves on from the landing that was the subject of the image and comment mentioned above.

Referring further to FIG. 6A, in the example shown, the playback interface 600 includes a timeline display and control area 606. In some embodiments, a playback head indicator and control 608 indicates a place on a displayed timeline 610 with which the portion of the content feed currently being displayed in the content display portion 602 of interface 600 is associated. In some embodiments, a user may select and drag the playback head indicator 608 left or right along timeline 610 to navigate quickly to another portion of the content feed.

In the example shown, the timeline 610 includes displayed information indicating for some moments along the timeline a relative degree of intensity of interest (e.g., popularity, volume of content, etc.). In this examples, circles of varying size are arranged along the timeline, e.g., to identify “hotspots” of content or greater interest along the timeline with that content feed. For example, in the ski jump event example mentioned above, a short spike in content, activity, interest, etc. associated with a competitor's performance that generated a certain spike in interest and/or content (e.g., social media comments) at that moment in time may be represented on timeline 610 by a circle of certain size, and a portion of the event that generated even more intense interest and/or interest that was sustained for a longer period of time may be represented by a larger circle. In some embodiments, a portion of interest may be navigated to by selecting the circle used to represent the moment on the timeline 610, and/or by moving the playback head indicator 608 to that part of the timeline. In other embodiments, a representation other than the circles shown in FIG. 6A may be used to indicate portions of greater content and/or interest, such as amplitude, color, intensity, thickness, etc.

In the example shown, the interface 600 includes a set of content player controls 612. In some embodiments, selection of the “play” control in the center would start playback of the content feed starting from the portion associated with the current location of the playback head indicator 608. The controls immediately to the left or right of the “play” button may be used in various embodiments to “rewind” or “fast forward” more quickly to other portions of the content feed. Finally, the leftmost control may be used to jump to the start and the rightmost control may be used to jump to the end of the content feed.

In some embodiments, the pace/speed of content stream playback may be controlled (e.g., by a user, the system, etc.) similar to a digital video recorder (DVR). For example, content may be replayed in fast-forward, slow motion, real-time, and/or any other speed. In another example, content playback may be paused and/or it may possible to skip/jump to various points in time (e.g., a noteworthy/important point of time in an event) in the playback.

According to various embodiments, noteworthy points (e.g., key points) in time during an event or show that was indexed could be played at a different pace (e.g., a slower pace) than other less noteworthy portions of the event and/or show. In certain cases, this can be done manually by a user and/or an editor that decides that key points of the event or to highlight certain key content. It can also automatically be done by an algorithm that determines the importance of certain content.

In some embodiments, an algorithm may use interactions such as shares, retweets, views of content, clicks, and/or other parameters to determine content importance and/or popularity. The popularity, importance, and/or other factors may be used to determine (e.g., adjust) playback speed of the content (e.g., as discussed above).

In various embodiments, an arrangement of content (e.g., videos, social media postings, etc. as shown in the figure above) in a display may be determined based on the popularity, importance, and/or other factors associated with each displayed content set. For example, more popular content may occupy more space on a display, may be positioned closer to the center of the display, etc.

In some embodiments, a period of time that content is displayed may be determined based on popularity, importance, and/or other factors. For example, more popular/important content (e.g., a popular social media post) may remain in the display for a longer period of time.

FIG. 6B is a block diagram illustrating an embodiment of a content stream playback speed control interface. In various embodiments, the playback speed control 620 of FIG. 6B may be used to indicate and control explicitly the playback speed of a portion of a content stream, e.g. a portion currently being played. In the example shown, a playback speed control 622 may be dragged left or right as desired to decrease or increase the playback speed, e.g., from a slowest playback speed (or “pause”) at one end of a range of available speeds up to a maximum playback speed. In some embodiments, speed may be controlled by clicking and holding a corresponding control in a displayed set of content player controls, e.g., in control portion 612 of interface 600 in the example shown in FIG. 6A.

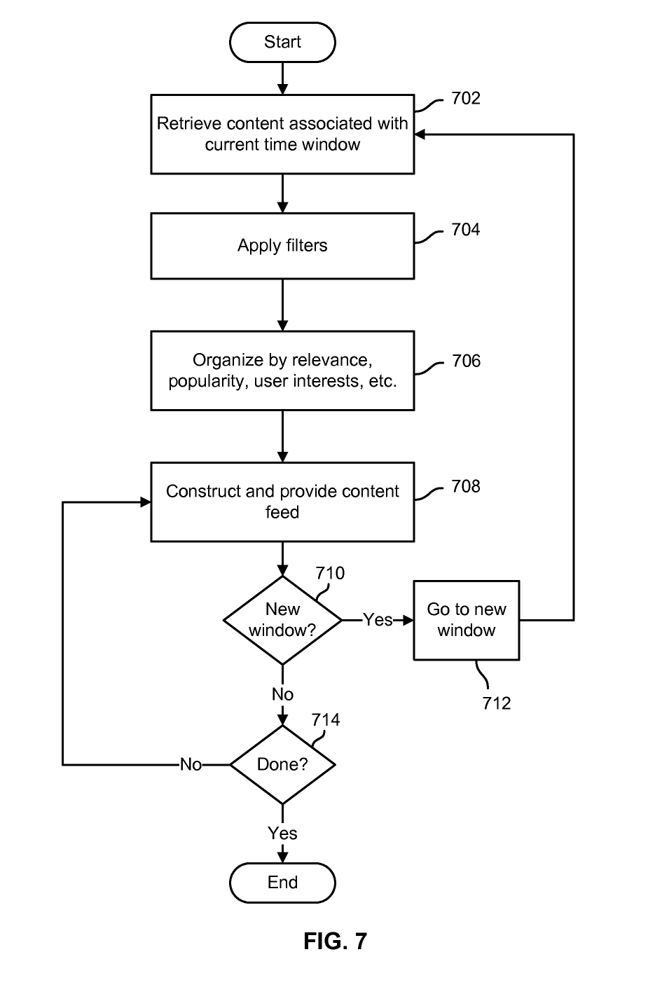

FIG. 7 is a flow chart illustrating an embodiment of a process to replay a content stream. In various embodiments, the process of FIG. 7 may be performed by a content stream server, such as content stream server 208 of FIG. 2. In the example shown, content associated with a current time window, e.g., a window that includes a current time being played and a prescribed amount of time before and after the current time, is retrieved (702). For example, if the content stream has not yet begun to be played, an initial portion of the content stream, starting from the beginning of the event (content stream) timeline, may be retrieved. In some embodiments, time stamped index data may be used to retrieve content for the window. In some embodiments, content stream metadata generated previously by using index data to identify relevant content for that portion of the stream may be used. In some embodiments, the size of the window and/or quantity of content retrieved may be determined based on factors such as the current playback speed, the amount of content available for a given stream and/or the current window, etc. In some embodiments, content may be retrieved based on determinations other than and/or in addition to time, such as how much content that has not yet been played remains available, etc.

One or more filters (optionally, in some embodiments) may be applied (704). For example, content may be filtered by one or more of location, popularity, content, content type, content source, etc., to a select from the retrieved content a subset of content to be served to a particular user and/or set of users. For example, fans living in or near a city with which a first team playing in a sporting competition is associated, and/or who have been determined based on previously observed user behavior to be a fan of the first team, may receive a content stream that has been filtered to include relatively more, primarily, and/or exclusively content from other area residents and/or fans.

Content is organized by relevance, popularity, user interests, etc. to determine for each portion of the content stream within the time window a selection, arrangement, relative size of display, and representative content (e.g., preview image, headline, excerpt text, etc.) to be displayed to represent the content item in the stream as displayed to the end user (706). In various embodiments, the selection and arrangement of content may be made programmatically based at least in part on an awareness of the type of device being used to play the content stream. In some embodiments, learned and/or explicitly expressed user preferences may be used, e.g., read from a user profile, to determine the content and/or arrangement of content in the content stream as provide to a given user.

The content feed is constructed and provided to the user (708). For example, content items and/or links thereto and metadata, client side code (e.g., scripts), and/or other data may be sent to the client device to enable the content stream to be played at the client device.

If an indication is received to retrieve data for a next or other new window (710), the system determines the window to be retrieved (712) and repeats the above steps of retrieving content, applying filters, organizing content, and constructing and serving that portion of the content feed. Examples of an indication to retrieve data for a next window include, without limitation, a time based threshold relative to which portion of a current window has already been played and/or how much remains to be played, how much content is associated with the portion of the current window that remains to be played, and/or user input, such as fast forwarding or manually jumping to another place on the event (content stream) timeline, e.g., using a user interface control such as playback head control 608 of FIG. 6A.

Processing continues until done (714), e.g., the user is no longer viewing the content stream.

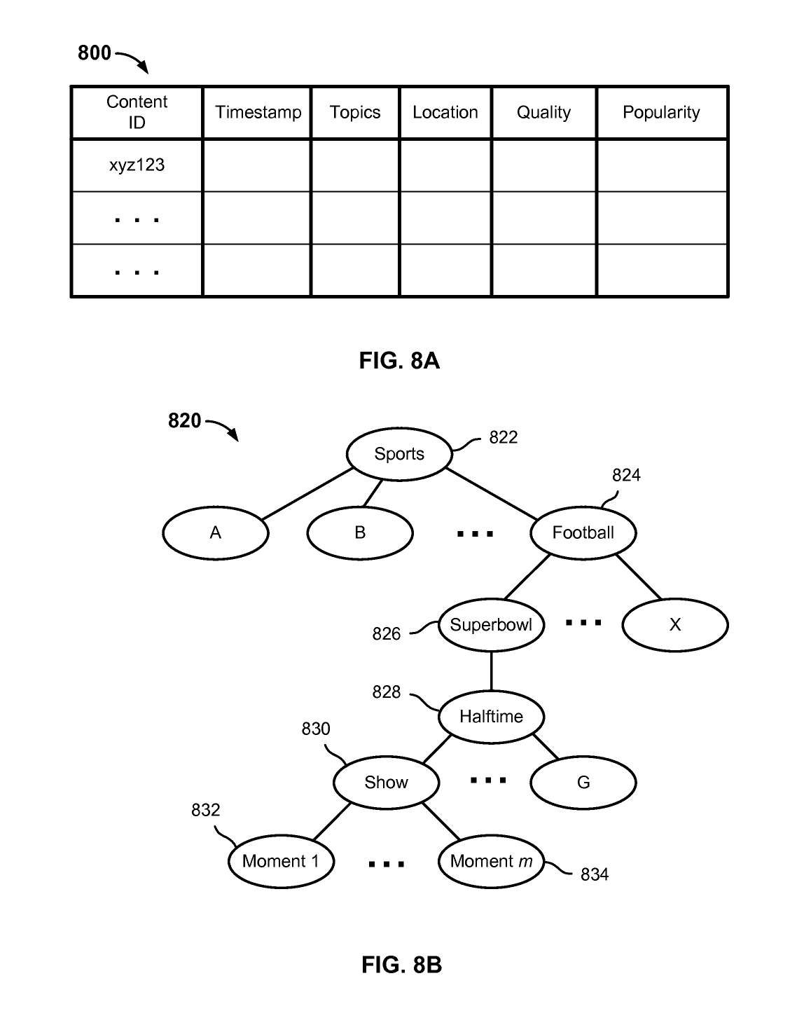

FIG. 8A is a block diagram illustrating an embodiment of a content index data structure to provide a replayable content feed. In various embodiments, an index such as the one shown in FIG. 8A may be created by an indexing engine, such as indexing engine 210 of FIG. 2, and/or used by a content stream generation system, such as system 102 of FIG. 1 and/or replayable content feed server 208 of FIG. 2, to construct and provide a replayable content feed. In the example shown, the index table 800 includes for each of a plurality of content items a timestamp; topics, events, or other categories of information with which the content item has been determined to be associated; location data (if available); quality data (e.g., machine-determined image or video quality, linguistic analysis of text content, etc.); and popularity data (e.g., likes, hearts, etc.).

While an index table is shown in FIG. 8A, in various embodiments any data structure and/or system may be used to store index data.

FIG. 8B is a block diagram illustrating an example of a portion of a taxonomy to classify content in an embodiment of a content stream generation and/or playback system. In some embodiments, a taxonomy such as the taxonomy 820 of FIG. 8B may be used to classify and cluster content items by topic, sub-topic, etc. In some embodiments, all or part of the taxonomy may be derived from content items, for example by using natural language processing and/or other techniques to discern topics programmatically from a body of content. In some embodiments, statistical methods may be used to determine the taxonomy and to use the taxonomy as a model to determine the topical relevance of subsequently process content items. In some embodiments, a taxonomy such as the one shown in FIG. 8A may be generated initially using machine (e.g., statistical) language processing techniques and may be edited by a human user, e.g., based on domain knowledge, etc., to achieve a set of topics and sub-topics that may be more useful for purposes of generating and providing a replayable content feed as described herein.

In the example shown in FIG. 8B, the taxonomy 820 includes a top level topic or category 822, “sports” in this example, which in some embodiments may be a child topic of a higher order category, such as “events” (see, e.g., FIG. 4). In this example, the category/topic “sports” 822 has a child node “football” 824 which in turn has a child node 826 associated with the Superbowl. The sub-topic “Superbowl” 826 in turn has a child node 828 associated with the “Halftime” portion of the Superbowl. A halftime “show” sub-topic 830 of the halftime sub-topic 828 includes a plurality of “moments”, represented in this example by sub-topics 832 and 834. In various embodiments, content items determined to be associated with the halftime show portion of the Superbowl may be further determined to be associated with one or more of these “moments” during the show, which sub-topics may be determined based on the content of the content items themselves, such as keywords or other frequently occurring text (e.g., co-occurring words), social media or other tags (e.g., #LeftShark), image tags, etc.

In various embodiments, the taxonomy may be refined over time, e.g., as the significance, meaning, level of interest, etc. of a portion of event-related content becomes more clear in the time following the event, e.g., as determined based on content generated about the event subsequent to its completion, such as comments on and/or indications of popularity of event related content, reviews or other articles about the event and/or associated content, etc.

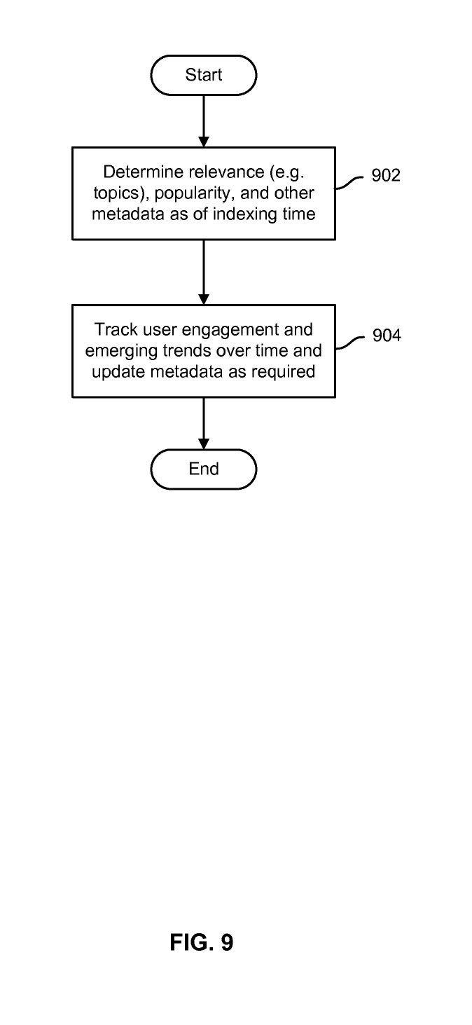

FIG. 9 is a flow chart illustrating an embodiment of a process to update index metadata. In various embodiments, the process of FIG. 9 may be implemented by an indexing engine, such as indexing engine 210 of FIG. 2. In the example shown, the relevance (e.g., topics), popularity, location, quality, and/or other content metadata is determined at the time a content item is first indexed (902). User engagement with the content item and/or related content and/or emerging trends across content items and/or content feed users are observed over time, and if indicated content item metadata may be updated (904), e.g., by updating an index entry for the content item in an index, such as the index table shown in FIG. 8A.

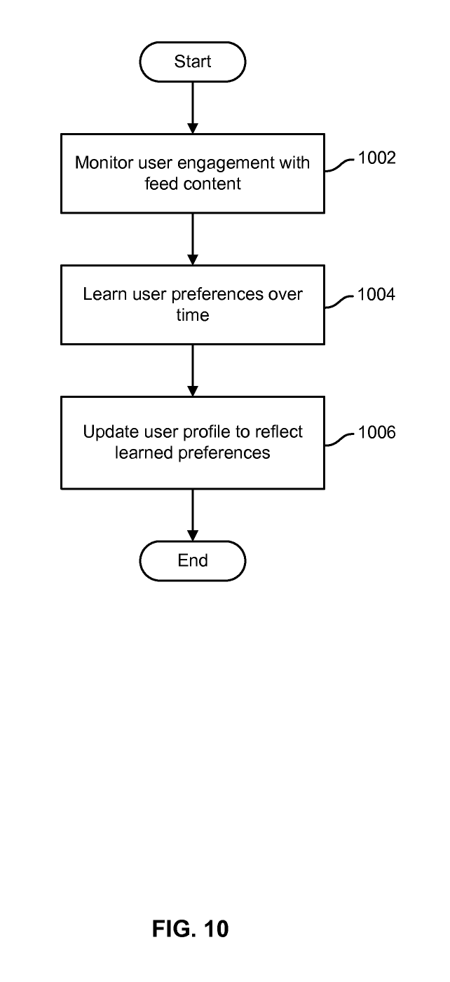

FIG. 10 is a flow chart illustrating an embodiment of a process to learn user preferences. In various embodiments, the process of FIG. 10 may be implemented by a content feed server, such as server 208 of FIG. 2, to create and maintain a user profile, such as one stored in a user profile database, e.g., user profile database 226 of FIG. 2. In the example shown, user engagement with content feeds is monitored (1002). For example, how quickly a user plays different portions of a content feed, which portions the user clicks on to interact with (e.g., play video clip, read full article, etc.), how long the user engages with each content item, which types of content the user often, infrequently, or never interacts with, etc., may be tracked. User preferences are learned over time (1004) based on such observations, and used to update the user's profile to reflect such learned preferences (1006). For example, if a user often engages with Instagram posts but rarely with Twitter content, then in the future less or no Twitter content and/or more Instagram posts may be included in content feeds provided to that user. In another example, a user who frequently views video content may have more video clips included in content feeds as provided to that user. A users affinity to a location, e.g. a place where the user formerly lived, may be discerned over time, and the affinity used to filter content feeds to include for that user more content associated with that location, etc.

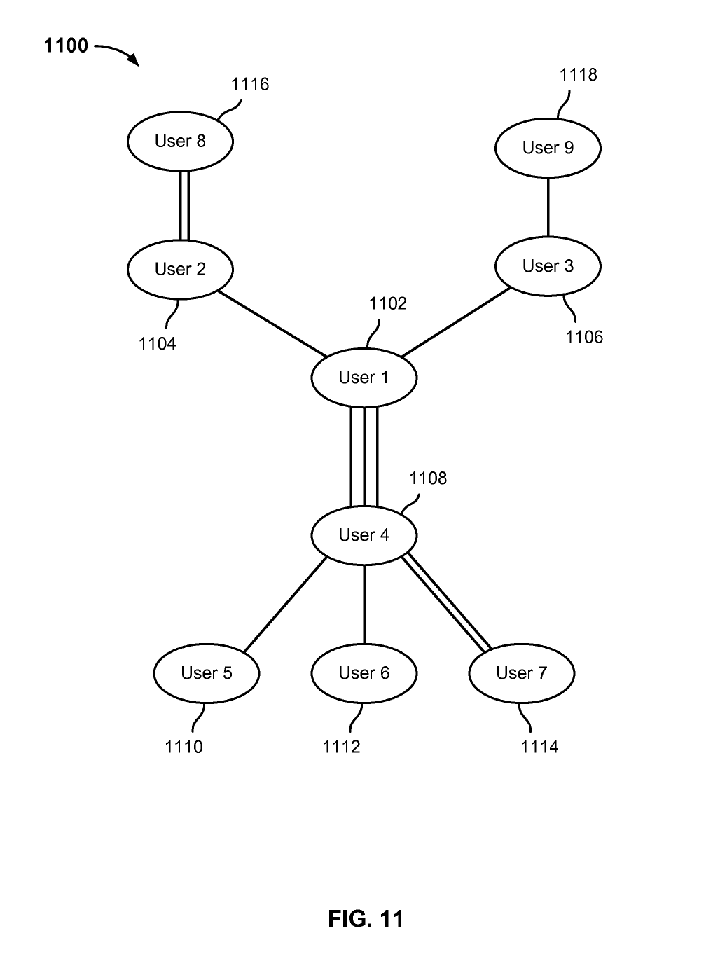

FIG. 11 is a block diagram illustrating an example of a social graph such as may be used in an embodiment of a content stream creation and/or playback system. In a various embodiments, a social graph such as the one shown in FIG. 11 may be used by a replayable content feed server, such as server 208 of FIG. 2, to determine content for a particular user, e.g., by filtering as in the process of FIG. 7. In a various embodiments, a content feed as provided to a given user may be determined at least in part by including and/or promoting within the feed content that is associated with others in the user's social graph, such as content contributed by and/or popular among the user's friends and/or content that is similar to such content.

In the example shown in FIG. 11, the social graph 1100 includes a plurality of users connected directly or indirectly by connections indicated by the lines between users. In this example, two more lines are shown to reflect “closeness” of relationships and/or that two users are related along more than one dimension, e.g., across multiple social networks, multiple shared interests, similar in terms of content they have expressed interest in, etc. In this example, a first user 1102 is shown to be related to three other users 1104, 1106, and 1108. The relationship to user 1108 is shown to be particularly close, as indicated by the three lines joining those users (1102, 1108). In this example, a content feed as provided to user 1102 may reflect preferences and/or content contributed by and/or popular among the user's immediate neighbors in the graph (1104, 1106, 1108) and, in some embodiments, those of next degree neighbors of the user 1108 to whom the user 1102 is closely related (e.g., 1110, 1112, 1114), but not the next degree neighbors of users (1104, 1106) to whom the user 1102 is less closely related (e.g., 1116, 1118).

In some embodiments, a social graph such as the one shown in FIG. 11 may include edges defined by and/or otherwise associated with one or more topics that have been determined to be commonly of interest to two or more related users. For example, if user 1102 and user 1104 have been determined to have a shared interest in football, then for purposes of a content feed associated with the Super Bowl the relationship between users 1102 and 1104 may be weighted more heavily. In some embodiments, content associated with a (strongly related) next degree neighbor of user 1104, e.g., user 1116, may in such a case be more likely to be included in a content feed as presented to user 1102 on a subject determined to be of common interest to the first degree neighbors (1102, 1104) in the graph 1100.

In some embodiments, the content feed platform/server allows users to sign-in and then connect to their existing social networks, thereby allowing users to share event and location content to their social connections.

In various embodiments, users can set in-app alarms and place calendar reminders to tune-in to live event feeds and/or view the DVR recording when the event concludes. Invitations to watch recordings can be sent from the platform/server to the user's friends.

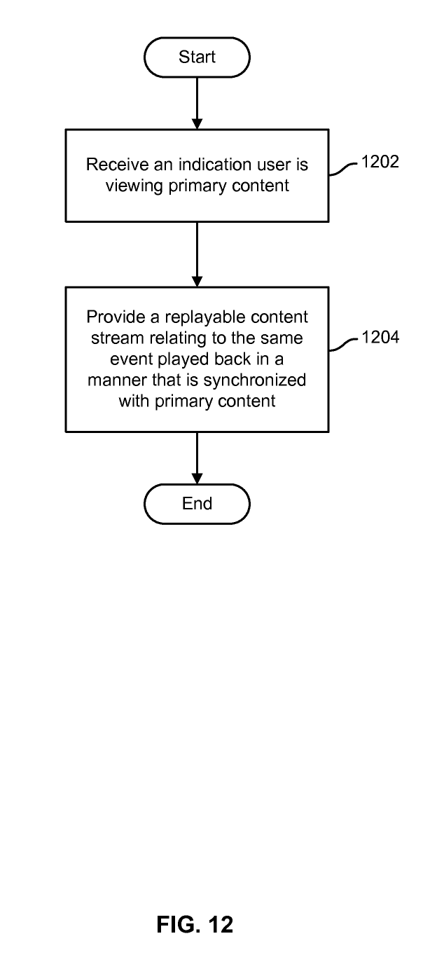

FIG. 12 is a flow chart illustrating an embodiment of a process to provide synchronized playback of a content stream. In various embodiments, the process of FIG. 12 may be performed by a content feed server, such as server 208 of FIG. 2, e.g., to provide a content feed that is synchronized to another broadcast/feed, such as television or other recorded broadcast of an event. In the example shown, an indication is received that a user is viewing a primary content of an event (1202). For example, the user may sign in to a content feed service and indicate the user is about to watch a pre-recorded event on the television, an on demand movie, etc. A replayable content stream relating to the same event or other primary content (e.g., movie, etc.) is provided in a manner that is synchronized with the primary content (1204).

In various embodiments, audio syncing may be processed by analyzing the audio wave spectrum originating from the television or online video/audio stream and comparing it to previously the recorded content files for patterns and then matching.

According to some embodiments, a microphone and/or other device may be used to record audio, video, and/or other content. And a content/social stream can be synced with other content such as a TV show. For example, a television program may be recorded (e.g., using a DVR and/or similar approach), and content (e.g., social media content) related to the TV show that is published (e.g., posted) during the show may be synchronized with the TV show. Using this approach, the TV show may be replayed along with the synchronized content related to the show (e.g., discussing the show, including a hashtag related to the show, etc.) that was posted during the broadcast of the show.

Providing a synchronized content stream may enable a user to participate and/or experience more meaningfully the social network postings by friends and others that were made as such other people viewed the event at a prior time, e.g., live on television, live at the event, and/or pre-recorded but viewed by that other person at a prior time. Each user's reactions to the primary content may be captured by the system over time and used to provide a content feed that may give the content feed user an experience similar to one they may have had had they and their friends been able to consume the primary content at the same time.

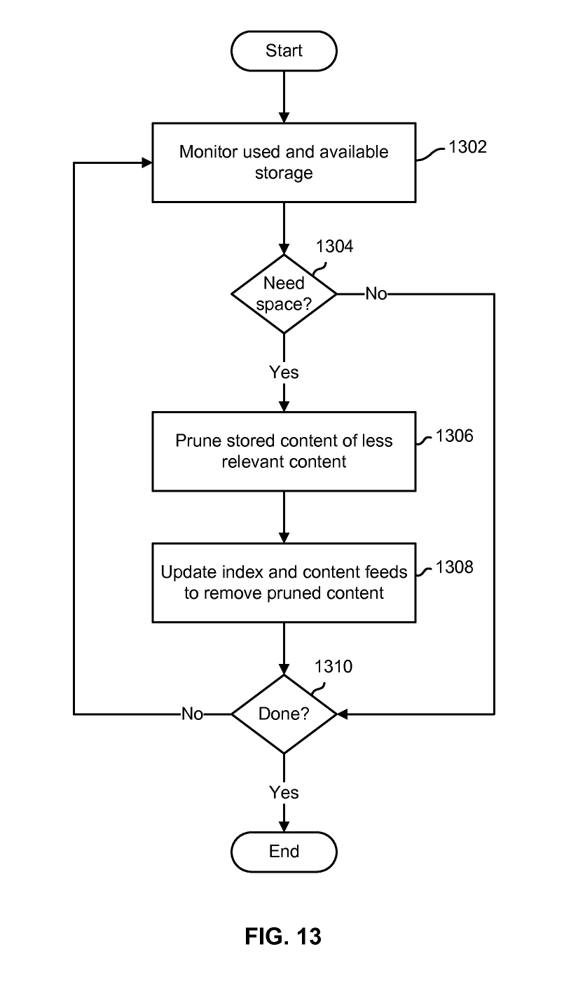

FIG. 13 is a flow chart illustrating an embodiment of a process to manage content storage. In various embodiments, the process of FIG. 13 may be performed by an indexing engine, such as indexing engine 210 of FIG. 2, and/or a content feed server, such as server 208 of FIG. 2, to manage storage space on a content storage device and/or system, such as content store 222 of FIG. 2.

Various approaches may be used to determine/select/identify content for storage. In various embodiments, all content related to, for example, a keyword, time period, location, and/or any other criteria may be stored. For example, all content that is related to the Olympics, broadcast during the time of the Olympics, and/or broadcast from an Olympic venue may be stored (e.g., recorded).

In some cases, the volume of content may be large (e.g., too large for efficient storage, processing, etc.), and an algorithm may be used to determine what content is saved (e.g., is worthwhile to save/store). This algorithm may be relative to the event by establishing a dynamic mean after the event is indexed or once a certain content storage threshold is hit. These and/or other approaches (e.g., filtering approaches) may be utilized to avoid storing too much data.

According to various embodiments, the platform may determine keywords, topics, locations, and/or other data that are trending. And content related to the trending data may be stored. For example, the platform may monitor various content feeds, and may detect when a keyword, hashtag, location, etc. is trending. It may be determined, for example, that a keyword is trending if the keyword is identified a certain number of times (e.g., a threshold number) over a period of time. Upon detection that a keyword is trending, content (e.g., all content) including that keyword may be stored.

In the example shown in FIG. 13, a storage device, system, and/or area used to store content data is monitored (1302). If more space is needed (1304), e.g., for newer, more popular, or otherwise currently more valuable content, the stored content is pruned to remove less relevant/useful content (1306) and associated index entries and content feeds are updated (1308), e.g., to remove references to content that is being removed from the content store. The process is repeated (1310) as needed, e.g., periodically and/or as available storage thresholds are reached.

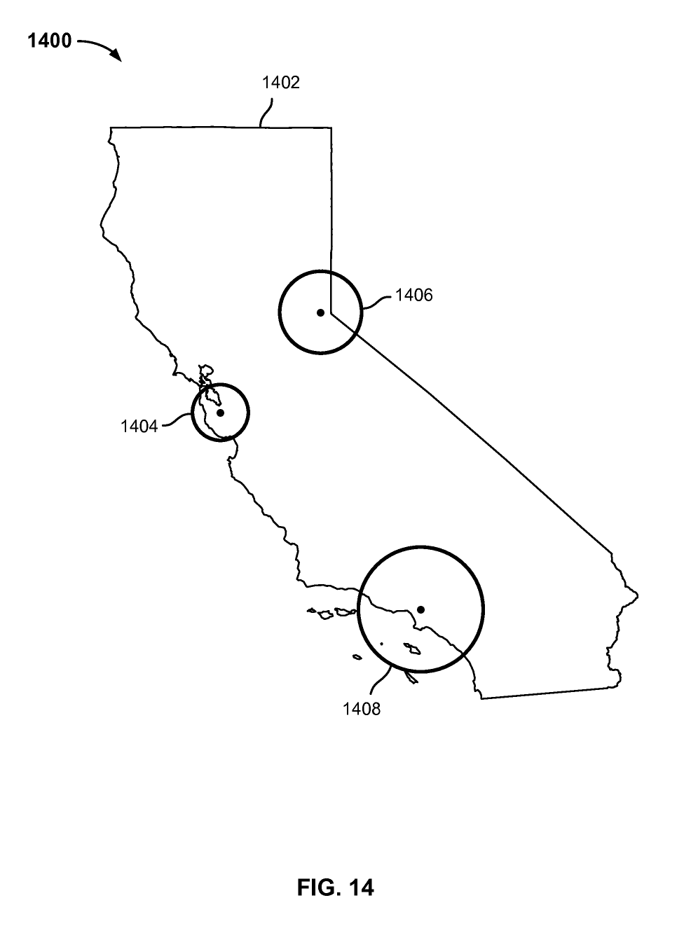

FIG. 14 is a diagram illustrating an example of a location-based content stream discovery interface in an embodiment of a content player system. In various embodiments, the user interface of FIG. 14 may be provided by a content feed server, such as server 208 of FIG. 2, and/or content player code running on a client device, such as devices 202, 204 of FIG. 2. In the example shown, a geographic location based user interface 1400 includes a map image 1402 of a relevant geographic area and at each of a plurality of locations on the map 1402 a corresponding representation of an event or other location-specific topic for which a corresponding content feed is available. In this example, content feeds associated with the areas at or near San Jose, Lake Tahoe, and Los Angeles (1404, 1406, and 1408) are shown to be available. Each event (1404, 1406, 1408) is represented by a circle, the relative size of which may indicate one or more of the popularity of that event among users generally; a volume, quality, or other measure of content associated with the event; a degree of alignment with the user's known interests; etc. Selection of the circle (or other representation) of a content item in various embodiments would result in access to the associated content feed being provided (e.g., FIGS. 5, 6A).

In some embodiments, zooming in or out may result in more specific or more general geographic areas being displayed. At each scale, a prescribed number of most relevant events and/or other content feeds may be represented. For example, in the example shown a user gesture or other input to zoom in on the San Jose area (1404) may result in a more detailed map of that area being displayed, and one or more other content feeds in addition to the one shown in FIG. 14 (1404) may be displayed. Conversely, zooming out may result in a map of the United States being displayed, and at that scale only the currently most popular event in California (1408) may be displayed, along with a events at other locations throughout the country.

According to various embodiments, location data may be tagged to content items. Using this data and/or local beacons (e.g., low power Bluetooth, iBeacon, Estimote beacons, etc.), event coverage can be viewed by location. For example, users can click on a location map and see all the social content from a specific place. They can also then replay that content using a timeline function and/or location path of content.

In various embodiments, the platform may deliver content to users based on their particular location and/or notify users of events that are nearby and local trending content. For example, a user's mobile device location, internet protocol (IP) address, network connection details (e.g., WiFi connection details, internet service provider (ISP) details, etc.), and/or any other location related data may be used to identify a user's location. Based on the identified location (e.g., of a device), content may be selected and provided to the user.

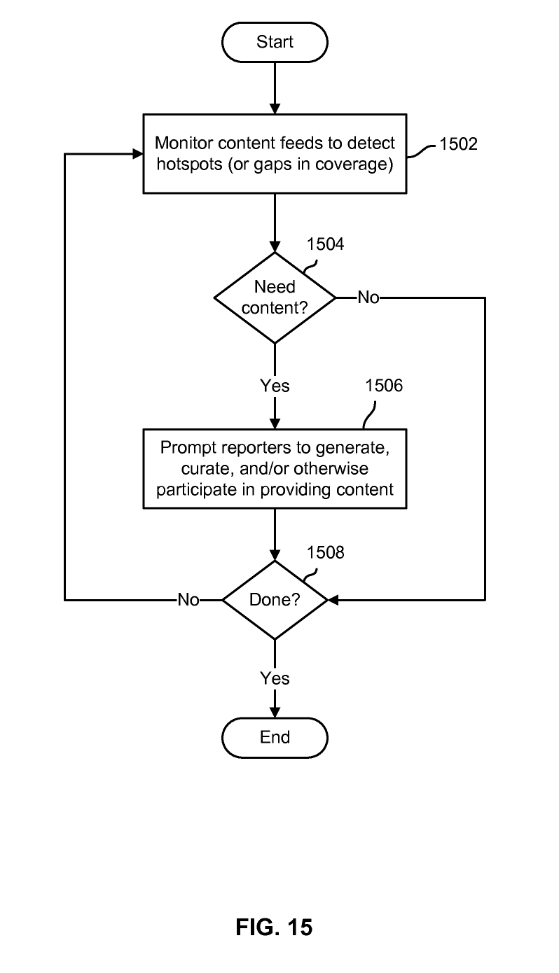

FIG. 15 is a flow chart illustrating an embodiment of a process to prompt users to provide content. In various embodiments, the process of FIG. 15 may be performed by a content feed server, e.g., server 208 of FIG. 2, and/or an indexing engine, e.g., indexing engine 210 of FIG. 2. In the example shown, content feeds are monitored to detect hotspots, such as spikes in content being generated about an event, and/or dead zones during which not much new content appears to be getting generated about an event (1502). If more content is determined to be needed (gaps in coverage) and/or there is determined to be a need to sort through a spike in the volume of content to ensure the most useful content gets promoted within the system and included in content feeds (1504), then users are prompted to generate, submit, and/or participate in a user-sourced effort to curate and promote content, as needed (1506). Subsequent iterations of prompting users to participate may be performed as needed, e.g., until the event ends (1508).

In some embodiments, requests can be made to “reporters”, “photographers” and “editors” that are covering an event to provide content (e.g., articles, video, etc.) related to the event. For example, a user may request that a reporter provide additional coverage of a specific aspect of an event, and a report may respond by providing the requested additional coverage. In certain cases, a point system and/or other tracking approach may create an incentive structure for these contributors to respond to these requests. Using this approach, users may be able to influence content generation related to an event.

According to some embodiments, natural language processing may be used to evaluate questions and/or “requests” that users have made to the platform. Employing this approach, the platform may scour content feeds and return matches if they exist, answering user's requests automatically.

Users may be invited and/or permitted to participate interactively in a two-way communication process, to enable content feeds that are rich in content that may be of the greatest interest to users to be provided.

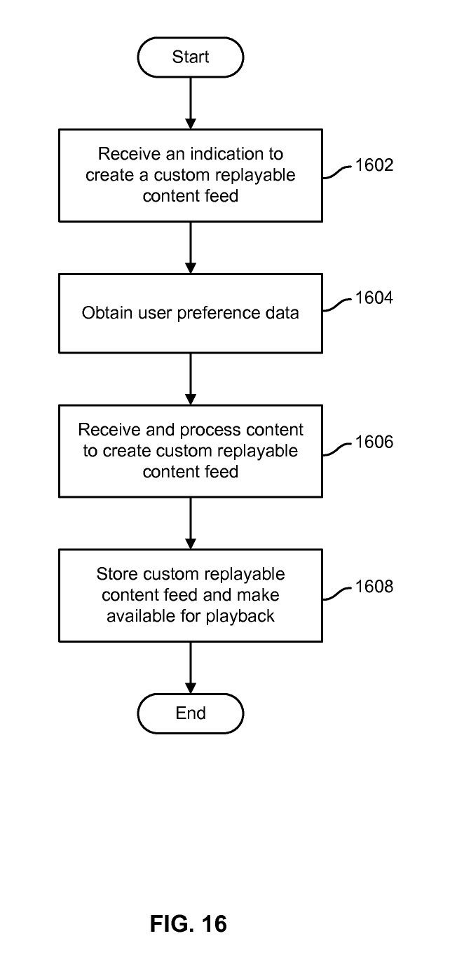

FIG. 16 is a flow chart illustrating an embodiment of a process to create a custom content feed. In various embodiments, the process of FIG. 16 may be performed by a content feed generation system, such as system 102 of FIG. 1 and/or one or both of content feed server 208 and indexing engine 210 of FIG. 2.

In some embodiments, the platform provides users the ability to “record” an event feed even if it is not listed as a featured event. A user can then have the recording waiting for them to watch television shows or catch up with other events and places at a later time. For example, users may be able to generate customized content recordings by providing keywords (e.g., Olympics), locations (e.g., a stadium hosting the event), periods of time, content sources (e.g., social media sites, websites, etc.), and/or any other criteria. Based on these criteria, the platform may record content (e.g., social media content, etc.) related to the criteria, and the content may be played back (e.g., on demand) to the user. In one example, the recorded content may be synchronized to a recorded broadcast of the event (e.g., the Opening Ceremonies), and the synchronized broadcast and recorded content may be played back to the user (e.g., at the user's discretion).

In the example shown in FIG. 16, an indication is received to create a custom replayable content feed (1602). For example, a user may request that a content feed be created for an event that has not already been identified as a feature event. Or, a user may request that a feed that includes and/or weights more heavily content of a certain type, from a certain perspective, etc. be created. User preference data for the requesting user is obtained (1604), e.g., from a user profile. Content is obtained and processed to create a custom content feed (1606). In some embodiments, user profile data may be used to select content to be included in the feed. The custom content feed is stored and made available to be played back by the requesting user and/or others (1608).

According to some embodiments, an “intelligent” custom or other content feed may allow users to view the best social content without having to filter. Popular content may be weighted from native attributes such as Likes, Re-Tweets, Hearts, Favorites, etc., allowing users to get the best recording possible from all the user generated content in the feed. Machine learning algorithms may be employed to allow the platform to deliver a more valuable stream to users based on what they themselves share, like, favorite, etc. For example, less popular/important content may be filtered out of the feed and/or featured less prominently (e.g., displayed in a smaller size, displayed for a shorter duration, etc.). In various embodiments, a user may be provided the option to turn on/off an intelligent feed feature.

In various embodiments, the platform will also display users their choice of content based on the origin of the content itself (e.g., Facebook, Twitter, Instagram, YouTube). Users can choose to display tweets, posts, pictures, videos, etc. by selecting any or all of the feed sources.

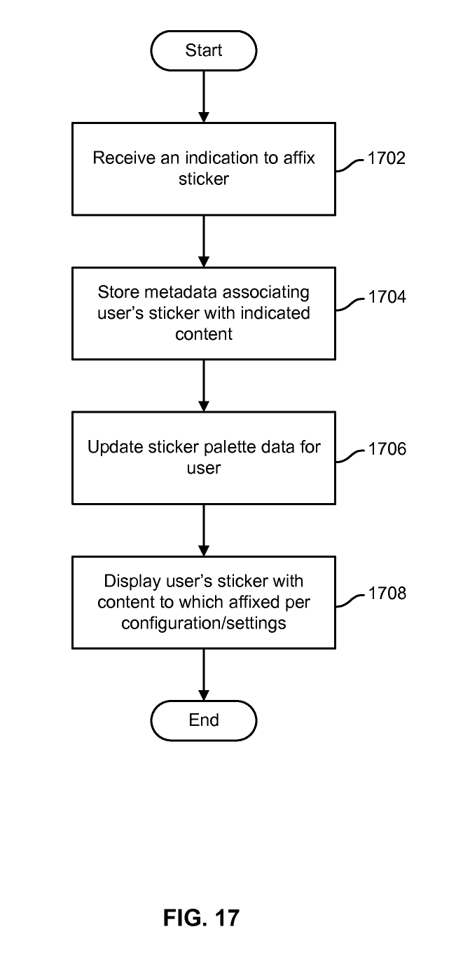

FIG. 17 is a flow chart illustrating an embodiment of a process to promote user engagement with content. In various embodiments, the process of FIG. 17 may be performed by a content feed server, such as server 208 of FIG. 2, and/or client side code running on a client device, such as devices 202, 204 of FIG. 2. In various embodiments, users may be provided with a set of single use virtual “stickers” or other virtual goods to be used to indicate a reaction of the user to an item of content in a content feed. In the example shown, an indication to affix a virtual sticker to an item of content is received (1702). Metadata associating the user's sticker with the content item is stored (1704). A sticker palette associated with the user may be updated to reflect that the user has used the sticker (1706). The user's sticker may be displayed with the content item to which the user has affixed the sticker, e.g., in connection with a representation of the content item as shown in a content feed in which the content item is included (1708). For example, friends of the use may see the sticker when they play the content feed. Stickers or other virtual items may be used to indicate positive or negative reaction to content, to draw the attention of other user's to content, to make a statement of affiliation, affinity, etc., for game play, or any other purpose. Additionally, communication may be sent back to the original poster of the content, notifying he/she of having received the accolade. This would occur in various embodiments as a post, comment, reply Tweet, etc.

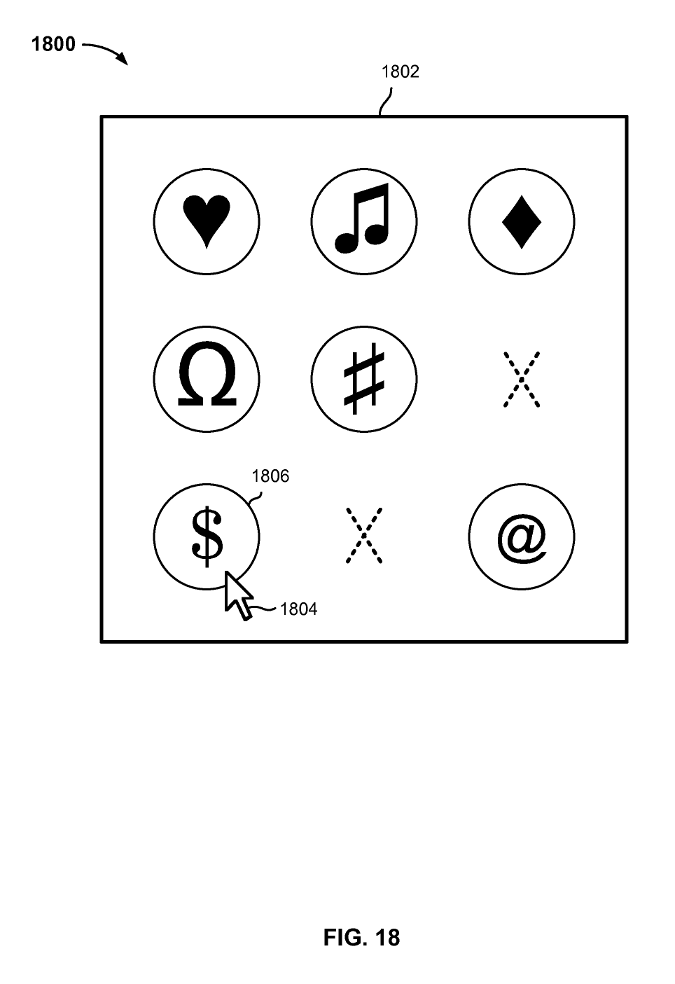

FIG. 18 is a diagram illustrating an example of a virtual “sticker” palette user interface in an embodiment of a content player system. In various embodiments, a sticker palette interface such as the one shown in FIG. 18 may be displayed by a client device configured to play a content feed, e.g., devices 202, 204 of FIG. 2. In the example shown, sticker palette 1800 includes a grid 1802 with locations for nine stickers, two of which have been used previously, as indicated by the “X” in dashed lines. A cursor 1804 has been used to select a sticker 1806, which in various embodiments may be dragged and dropped onto a representation of a content item, e.g., as represented in a content feed. In response to such a user input/gesture, in various embodiments an iteration of the process of FIG. 17 may be performed.

In various embodiments, techniques disclosed herein may be used to provide live, recorded, and/or replayable feeds of content associated with an event or other topic.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of providing content, comprising:
obtaining a time-stamped index of content items from a plurality of content sources, wherein the time-stamped index associates at least a subset of content items with an event; and
using the time-stamped index and said at least a subset of the content items to provide a content feed associated with the event, wherein the content feed includes content from at least two or more of said plurality of sources arranged at least in part by time through a duration of occurrence of the event.

2. The method of claim 1, further comprising receiving said content items from said plurality of content sources.

3. The method of claim 2, further comprising generating said time-stamped index of content items.

4. The method of claim 1, wherein the content feed is configured to be displayed on a client device.

5. The method of claim 1, wherein the content feed includes a simultaneous display of content from two or more sources for each time-based portion of the feed.

6. The method of claim 1, wherein the content feed is displayed in connection with a timeline interface that includes for each of one or more content hotspots a graphical indication that content associated with that portion of the time-based content feed may be of greater interested.

7. The method of claim 6, wherein the timeline interface includes a user control configured to be used by the user to jump to a portion of the content feed that is associated with a time indicated by the user via the user control.

8. The method of claim 1, wherein the content feed includes social media content comprising user generated content associated with the event.

9. The method of claim 1, wherein the content feed comprises a live feed that is generated and provided in real time, as the event occurs.

10. The method of claim 1, wherein the content feed is record and is configured to be played or replayed at a time subsequent to the event.

11. The method of claim 1, further comprising filtering content associated with the content feed to create a set of filtered content to be included in the content feed as provided to a user.

12. The method of claim 11, wherein said filtering is performed based at least in part on a user profile of the user.

13. The method of claim 11, wherein said filtering is performed based at least in part on a location.

14. The method of claim 1, wherein the time-stamped index is updated over time to reflect subsequently-received information indicative of one or more of the topical relevance, quality, associated location, and popularity of the content.

15. The method of claim 1, further comprising organizing a set of content item within said content feed according to a taxonomy that includes a category and one or more subcategories of the category.

16. The method of claim 1, wherein content to be included in the content feed as provided to a user is determined based at least in part on a graph of relationships between that user and one or more other users.

17. The method of claim 1, further comprising providing a map-based user interface to enable a user to discover content by location.

18. The method of claim 1, further comprising prompting one or more users to participate in one or more of the generation, curation, and promotion of content to be included in the content feed.

19. The method of claim 1, wherein the content feed comprises a custom content feed created at the request of a requesting user.

20. The method of claim 1, further comprising providing a virtual goods user interface to enable a user to associate with a content item included in a content feed a virtual good associated with the user.

21. A system to provide content, comprising:
a communication interface; and
a processor coupled to the communication interface and configured to:
obtain via the communication interface a time-stamped index of content items from a plurality of content sources, wherein the time-stamped index associates at least a subset of content items with an event; and
use the time-stamped index and said at least a subset of the content items to provide a content feed associated with the event, wherein the content feed includes content from at least two or more of said plurality of sources arranged at least in part by time through a duration of occurrence of the event.

22. A computer program product to provide content, the computer program product being embodied in a computer readable storage medium and comprising computer instructions for:
obtaining a time-stamped index of content items from a plurality of content sources, wherein the time-stamped index associates at least a subset of content items with an event; and
using the time-stamped index and said at least a subset of the content items to provide a content feed associated with the event, wherein the content feed includes content from at least two or more of said plurality of sources arranged at least in part by time through a duration of occurrence of the event.
